(19) United States
(12) Patent Application Publication
(10) Pub. No.: US 2024/0289619 A1
(43) Pub. Date: Aug. 29, 2024

(54) GRADIENT-FREE STRUCTURED PRUNING OF NEURAL NETWORKS

(71) Applicant: Google LLC, Mountain View, CA (US)

(72) Inventors: Azade Nova, San Jose, CA (US); Hanjun Dai, Atlanta, GA (US); Dale Eric Schuurmans, Edmonton (CA)

(21) Appl. No.: 18/424,595

(22) Filed: Jan. 26, 2024

Related U.S. Application Data
(60) Provisional application No. 63/441,439, filed on Jan. 26, 2023.

(51) Int. Cl. G06N 3/082; G06N 3/048

(52) U.S. Cl. CPC G06N 3/082; G06N 3/048

(57) ABSTRACT

Methods, systems, and apparatus, including computer programs encoded on computer storage media, for performing a machine learning task on a network input to generate a network output. One of the methods includes: obtaining data specifying an initial neural network configured to perform a machine learning task; a representativeness measure for each of a plurality of filters; determining a central tendency measure for the plurality of filters based on processing a batch of network inputs using the initial neural network; determining a cumulative importance score for each of the plurality of filters; selecting a proper subset of the plurality of filters; and generating a pruned neural network configured to perform the machine learning task.

### CROSS-REFERENCE TO RELATED APPLICATION

This application claims priority to U.S. Provisional Application No. 63/441,439, filed on Jan. 26, 2023. The disclosure of the prior application is considered part of and is incorporated by reference in the disclosure of this application.

### BACKGROUND

This specification relates to neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of weights.

A general trend with neural networks has been to make larger and more complicated networks in order to achieve higher accuracy. As neural networks increase in size and complexity in service of increased accuracy, so too do they increase in computational cost. This trend toward larger and more complicated networks may be problematic in the context of computing environments where certain computing resources, such as memory and processing capability, are limited. For example, mobile computing devices and/or embedded computing present challenging environments for the implementation of such large and complicated networks.

### SUMMARY

This specification describes a neural network architecture pruning system implemented as computer programs on one or more computers in one or more locations that obtains data specifying an initial architecture for a neural network that has been configured through training to perform a machine learning task and an unlabeled dataset and uses the unlabeled dataset to determine a pruned architecture for the neural network by pruning some of the filters in one or more layers of the neural network.

Particular embodiments of the subject matter described in this specification can be implemented so as to realize one or more of the following advantages.

The subject matter described in this specification can be implemented in particular embodiments so as to realize one or more of the following advantages. The gradient-frec structured pruning techniques described in this specification can generate a pruned neural network that has a reduced model size (i.e., fewer model parameters), a less complex model architecture, or both compared with an initial neural network from which the pruned neural network is generated. With the reduction in model size and architecture complexity, both the runtime latency and resource, e.g., memory and processing power, consumption will be reduced when computing an inference using the pruned neural network.

The pruned neural network can more practically run on an edge device, e.g., a smartphone or laptop computer, than the initial neural networks that may be computationally too demanding, and yet achieve comparable accuracy when performing a same machine learning task. For example, given a neural network that has a high task performance but is too large in terms of model size to be deployed on a particular device, e.g., has a large number of parameters that don't fit in the memory of the particular device, the described gradient-free structured pruning techniques can generate a pruned neural network with a smaller model size that is more practical for deployment on the particular device, e.g., has a small enough number of parameters to fit in the memory, and that still maintains approximately the high task performance.

In particular, by ranking the feed-forward layer filters in the initial neural network based on an importance ranking of the filters that can be generated based on the model parameters of the initial neural network that were already learned during the training as well as on a relatively small dataset which need not be labeled, the gradient-free structured pruning techniques described in this specification can effectively determine which filters in each of one or more layers to prune without causing an excessive loss in the accuracy of the pruned neural network. Compared with other existing pruning or distillation-based model compression techniques that require re-training of the pruned neural network to regain accuracy, applying the pruning techniques can more quickly and more computing resource-efficiently obtain the pruned neural network because no further training of the network will be needed.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network architecture pruning system.

FIG. 2 shows an example of operations performed by the neural network architecture pruning system of FIG. 1.

FIG. 3 is a flow diagram of an example process for generating a pruned architecture for a neural network.

FIG. 4 is a flow diagram of sub-steps of one of the steps of the process of FIG. 3.

FIG. 5 is a flow diagram of sub-steps of another one of the steps of the process of FIG. 3.

Like reference numbers and designations in the various drawings indicate like elements.

### DETAILED DESCRIPTION

This specification describes a neural network architecture pruning system implemented as computer programs on one or more computers in one or more locations that obtains data specifying an initial architecture for a neural network that has been configured through training to perform a machine learning task and an unlabeled dataset and uses the unlabeled dataset to determine a pruned architecture for the neural network by pruning some of the filters in one or more layers of the neural network.

The neural network can have any architecture, e.g., a feed-forward neural network architecture or a recurrent neural network architecture. In some cases, the neural network is a language model neural network that has any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J.W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d′Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lec, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neclakantan, Pranav Shyam, Girish Sastry, Amanda Askell, et al. Language models are few-shot learners. arXiv preprint arXiv:2005.14165, 2020. The contents of each of these documents is incorporated by reference into this specification in its entirety.

The neural network can be configured through training to receive any kind of digital data input and to perform any kind of machine learning task (e.g., generative task, classification task, or regression task) on the input to generate an output. A few examples follow.

In some cases, the neural network is a neural network that is configured to perform an image processing task, i.e., receive an input image and to process the input image to generate a network output for the input image. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As another example, the task can be object detection and the output generated by the neural network can identify locations in the input image at which particular types of objects are depicted. As yet another example, the task can be image segmentation and the output generated by the neural network can assign each pixel of the input image to a category from a set of categories. In some other cases, the neural network is a neural network that is configured to perform an image generation task, where the input is a conditioning input and the output is a sequence of intensity value inputs for the pixels of an image.

As one example, the task may be a neural machine translation task. For example, if the input to the neural network is a sequence of text, e.g., a sequence of words, phrases, characters, or word pieces, in one language, the output generated by the neural network may be a translation of the sequence of text into another language, i.e., a sequence of text in the other language that is a translation of the input sequence of text. As a particular example, the task may be a multi-lingual machine translation task, where a single neural network is configured to translate between multiple different source language—target language pairs. In this example, the source language text may be augmented with an identifier that indicates the target language into which the neural network should translate the source language text.

As another example, the task may be an audio processing task. For example, if the input to the neural network is a sequence representing a spoken utterance, the output generated by the neural network may be a score for each of a set of pieces of text, each score representing an estimated likelihood that the piece of text is the correct transcript for the utterance. As another example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can be a classification of the spoken utterance into one of a plurality of categories, for example an identity of the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram, a waveform, or other data defining audio of the text being spoken in the natural language.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient. Such electronic health data may, for example, comprise one or more sequences of physiological data taken from a patient, with the output being a corresponding prediction that relates to those sequences of data. Examples of physiological data and a corresponding prediction include: blood glucose measurements, with the prediction being a predicted future blood glucose measurement or the prediction of a hyper- or hypo-glycemic event; a heart rate, with the prediction being the presence or absence of a heart condition, or a future cardiac event; blood pressure measurements, with the prediction being the risk of a future heart condition; or the like.

As another example, the task can be a text generation task, where the input is a sequence of text, and the output is another sequence of text, e.g., a completion of the input sequence of text, a response to a question posed in the input sequence, or a sequence of text that is about a topic specified by the first sequence of text. As another example, the input to the text generation task can be an input other than text, e.g., an image, and the output sequence can be text that describes the input.

As another example, the task can be an agent control task, where the input is a sequence of observations or other data characterizing states of an environment and the output defines an action to be performed by the agent in response to the most recent data in the sequence. The agent can be, e.g., a real-world or simulated robot, a control system for an industrial facility, or a control system that controls a different kind of agent. The observations may comprise sensor data captured by sensors associated with (e.g. part of) the agent, for example visual data, LIDAR data, sonar data, agent configuration data (e.g. joint angles), agent orientation data, or the like.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the system is configured to perform multiple different individual machine learning tasks, e.g., two or more of the machine learning tasks mentioned above. For example, the neural network can be configured to perform multiple individual natural language understanding tasks, with the input including an identifier for the individual natural language understanding task to be performed on the network input.

In some cases, the task is a multi-modal task that requires processing both text and image inputs, so that the neural network includes both a computer vision neural network and a text processing neural network. That is, the target output to be generated by the computer vision neural network for a given image depends on one or more outputs generated by the text processing neural network for one or more corresponding text inputs (and vice versa). Examples of such tasks include open-vocabulary image classification, open-vocabulary object detection, image captioning, text-based image search, image-based retrieval, and so on.

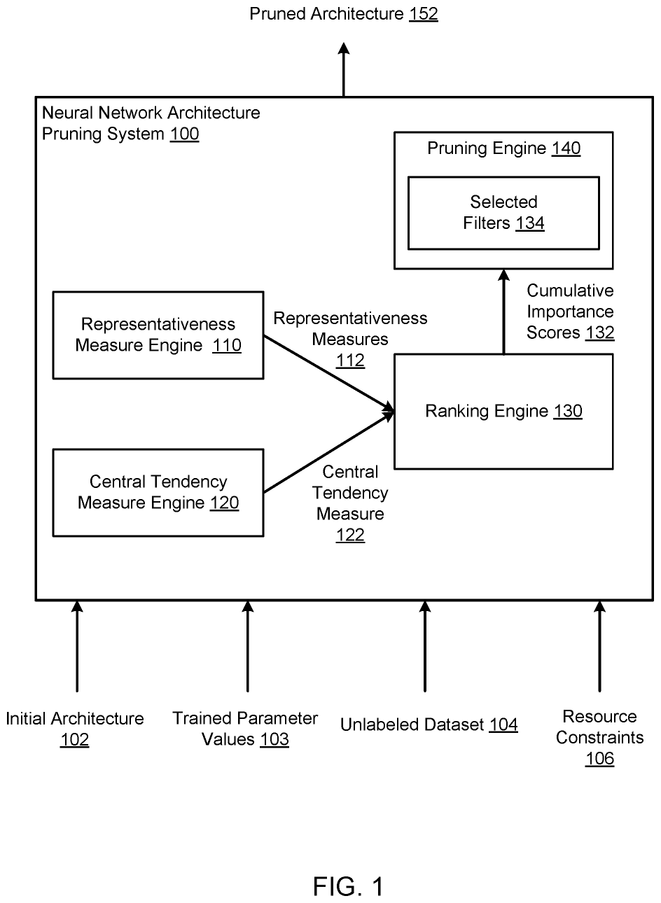

FIG. 1 shows an example neural network architecture pruning system 100. The neural network architecture pruning system 100 is an example of a system implemented as computer programs on one or more computers in one or more locations, in which the systems, components, and techniques described below can be implemented.

The neural network architecture pruning system 100 is a system that obtains an initial architecture 102 and trained values of the parameters 103 of a neural network that has been configured through training to perform the machine learning task and an unlabeled dataset 104, and uses the unlabeled dataset 104 to determine a pruned architecture 152 for the neural network to perform the machine learning task.

An architecture of the neural network defines the number of layers in the neural network, the number of filters included in each of the layers, and the connectivity between the filters included in the layers in the neural network, i.e., which layers receive inputs from which other layers in the neural network. For each layer, a filter is defined by a group of one or more parameters and can be applied, e.g., in accordance with the configuration of the layer, to an input to the layer to generate an output of the layer. The number of filters included in each layer determines the dimension of output of the layer.

The unlabeled dataset 104 includes a plurality of network inputs. The unlabeled dataset 104 is referred to as “unlabeled” because for each network input, information about a known network output, e.g., a ground truth network output that should be generated by the neural network from the network input for a machine learning task, may not be specified by unlabeled dataset 104 and thus may not be readily available to the neural network architecture pruning system 100.

In some implementations, the neural network architecture pruning system 100 also receives input data that specifies one or more resource constraints 106, e.g., from a user of the system. Generally, the resource constraints 106 specify how many computational resources can be consumed by the neural network that has the pruned architecture 152 when performing the task, e.g., while deployed on computing device(s).

In some examples, the resource constraints 106 can be defined with reference to the runtime latency of the neural network for performing an inference for an input or a batch of inputs, floating point operations per second (FLOPS) performed by the neural network while performing the task, the memory footprint of the neural network when deployed for performing the task, or some combinations thereof. In these implementations, the system can determine the pruned architecture 152 for the neural network that satisfies the one or more resource constraints 106.

In particular, the neural network architecture pruning system 100 determines the pruned architecture 152 for the neural network by pruning some of the filters in each of one or more layers of the neural network. Scaling down a number of filters in each layer of the neural network can result in a smaller, faster network and, when pruned using the gradient-free structured pruning techniques described in this specification, this will result in no or only a small loss of accuracy of the neural network that has the pruned architecture 152 when performing the one or more prediction tasks compared to the neural network that has initial architecture 102.

Generally, the neural network architecture pruning system 100 can obtain architecture data that defines the initial architecture 102, parameter data that defines the trained values of the parameter 103, or the unlabeled dataset 104 in any of a variety of ways. For example, the system can receive the architecture data, the parameter data that defines the trained values of the parameter, or the unlabeled dataset as an upload from a remote user of the system over a data communication network, e.g., using an application programming interface (API) made available by the system. As another example, the system can receive an input from a user specifying which data that is already maintained by the system, or another system that is accessible by the system, should be used as the architecture data, the parameter data that defines the trained values of the parameter, or the unlabeled dataset.

The initial architecture 102 can be any appropriate neural network architecture for performing the machine learning task. The initial architecture 102 generally has a plurality of neural network layers. In cases where the neural network is a language model neural network that has one of the Transformer-based neural network architectures mentioned above (or other Transformer-based neural network architectures), the initial architecture 102 for the neural network includes a plurality of feed-forward neural network layers. For example, each feed-forward neural network layer can be arranged subsequent to, or in parallel with, a corresponding multi-head attention layer within the neural network.

More specifically, each feed-forward neural network layer includes a first linear transformation layer that has a plurality of first linear transformation parameters, followed by a nonlinear activation layer, followed by a second linear transformation layer that has a plurality of second linear transformation parameters.

The plurality of first linear transformation parameters include the weights and, optionally, the biases of the first linear transformation layer. Analogously, the plurality of second linear transformation parameters include the weights and, optionally, the biases of the second linear transformation layer.

When in operation, the first linear transformation layer applies, in accordance with the trained values of the plurality of first linear transformation parameters, a first linear transformation to a layer input to the feed-forward neural network layer to generate a layer output of the first linear transformation layer.

The nonlinear activation layer applies a nonlinear activation function to the output of the first linear transformation to generate a layer output of the nonlinear activation layer. For example, the nonlinear activation layer can be a Gaussian error linear unit (GELU) activation layer that applies a GELU activation function. As another example, the nonlinear activation layer can be a rectified linear unit (RELU) activation layer that applies a RELU activation function. As another example, the nonlinear activation layer can be a sigmoid activation layer that applies a sigmoid activation function. As yet another example, the nonlinear activation layer can be a Swish activation layer that applies a Swish activation function.

The second linear transformation layer then applies, in accordance with the trained values of the plurality of second linear transformation parameters, a second linear transformation to the layer output of the nonlinear activation layer to generate a layer output of the feed-forward neural network layer.

For each feed-forward neural network layer, the plurality of first linear transformation parameters of the first linear transformation layer and the plurality of second linear transformation parameters of the second linear transformation layer collectively define a plurality of filters of the feed-forward neural network layer.

For example, a feed-forward neural network layer FFN^{l}(x) that has N filters can be defined as:

$$F F {N}_{ℓ} ( x ) = {\sum }_{i = 1}^{N} ( σ ( {xW}_{ℓ}^{( 1 )} [ : , i ] + {b}_{ℓ}^{( 1 )} ) {W}_{ℓ}^{( 2 )} [ i , : ] ) + {b}_{ℓ}^{( 2 )} ,$$

where Wₗ⁽¹⁾ E R^{d×N} is the weight matrix (a matrix of the weights) for the first linear transformation layer, Wₗ⁽²⁾ E R^{N×d} is the weight matrix for the second linear transformation layer, bₗ⁽¹⁾ ∈R^{N} is the bias vector for the first linear transformation layer, bₗ⁽²⁾ ∈R^{d} is the bias vector for the second linear transformation layer, o is the activation function, and x is the layer input to the feed-forward neural network layer. The notation [:, i] refers to the elements of the matrix along its i-th column, and notation [i, :] refers to the elements of the matrix along its i-th row.

The neural network architecture pruning system 100 includes a representativeness measure engine 110, a central tendency measure engine 120, a ranking engine 130, and a pruning engine 140.

The representativeness measure engine 110 is configured to, for each of the plurality of filters of a given feed-forward neural network layer included in the initial architecture 102, determine a representativeness measure 112 for the filter. The representativeness measure 112 indicates how representative each filter is of—or, put another way, how well each filter represents-all of the plurality of filters of the given feed-forward neural network layer.

In implementations, the representativeness measure engine 110 can use any representativeness determination techniques to compute the representativeness measures 112. For example, as will be described below, the representativeness measure engine 110 can use a convex hull approximation technique, which involves identifying a convex hull of the second linear transformation parameters of the second linear transformation layer, to compute the representativeness measures 112. For any linear function, the convex hull is a subset of data points that can be used to find the maxima of the linear function. It will be appreciated that other techniques, e.g., including those that use mutual information, entropy, relative entropy, or another measure of information, can also be used by the representativeness measure engine 110 to compute the representativeness measures 112.

The central tendency measure engine 120 is configured to, for each of the plurality of filters of the given feed-forward neural network layer included in the initial architecture 102, determine a central tendency measure 122 for the filter. To determine the central tendency measure 122 for each of the plurality of filters of the given feed-forward neural network layer, the central tendency measure engine 120 samples a batch of network inputs from the unlabeled dataset 104 and then, for each network input in the batch, perform a forward pass through the neural network using the network input to generate a layer output of the first linear transformation layer. The central tendency measure engine 120 then computes the central tendency measure for each of the plurality of filters based on output values included in the layer outputs of the first linear transformation layer that have been generated from processing the network inputs in the batch.

The ranking engine 130 is configured to, for each of the plurality of filters of the given feed-forward neural network layer included in the initial architecture 102, determine a cumulative importance score 132 for the filter based on (i) the representativeness measure 112 determined by the representativeness measure engine 110 for the filter, and (ii) the central tendency measure 122 determined by the central tendency measure engine 120 for the filter.

The pruning engine 140 is configured to, for the given feed-forward neural network layer included in the initial architecture 102, select a proper subset of filters 134 from the plurality of filters of the given feed-forward neural network layer based on their cumulative importance scores 132. A proper subset includes at least one filter from the plurality of filters, but less than all of the plurality of filters of the given feed-forward neural network layer.

In some implementations, the pruning engine 140 selects a fixed number of filters from each feed-forward neural network layer included in the initial architecture 102, i.e., the pruning engine 140 selects the same number of filters from each of the different feed-forward neural network layers.

For example, the pruning engine 140 can rank the plurality of filters of the given feed-forward neural network layer based on their cumulative importance scores 132 to generate a ranking, e.g., in the form of a sorted list or another data structure, of the plurality of filters for the given feed-forward neural network layer, e.g., the filter that has the highest cumulative importance score is at the top position of the ranking while the filter that has the lowest cumulative importance score is at the bottom position.

In this example, the pruning engine 140 can then select, as the proper subset of filters 134, filters that have the highest cumulative importance scores 132 amongst the plurality of filters of the given feed-forward neural network layer. In other words, the filters at the top k positions within the ranking for each feed-forward neural network layer will be selected.

In other implementations, the pruning engine 140 selects a varying number of filters from each feed-forward neural network layers included in the initial architecture 102, i.e., the pruning engine 140 selects a different number of filters from each of the different feed-forward neural network layers.

For example, for the given feed-forward neural network layer included in the initial architecture 102, the pruning engine 140 can select, as the proper subset of filters 134, filters that have cumulative importance scores 132 that are greater than a given cumulative importance score threshold.

As another example, the pruning engine 140 can generate a combined ranking for all of the plurality of feed-forward neural network layers included in the initial architecture 102 of the neural network based on their cumulative importance scores 132, and select filters at the top k positions within the combined ranking.

In these examples, the value of k can be a tunable parameter of the system. For example, the value of k can be a predetermined value, e.g., that is received from a user of the system. As another example, the pruning engine 140 can dynamically adjust the value of k based on the resource constraints 106. For example, the pruning engine 140 can determine the maximum number of filters across the plurality of feed-forward neural network layers included in the initial architecture 102 of the neural network that are allowed in the pruned architecture 152, in order to satisfy the resource constraints 106, and set k to a value that is no greater than the maximum allowed number.

For the given feed-forward neural network layer included in the initial architecture 102, after the proper subset of filters 134 has been selected, the pruning engine 140 is configured to generate a pruned feed-forward neural network layer that has the proper subset of filters 134, and that omits the remaining filters that are not in the proper subset. That is, the pruning engine 140 prunes the filters that have not been selected from the feed-forward neural network layer included in the initial architecture 102.

In some implementations, filters that are not in the proper subsets of filters 134 are pruned from the initial architecture by inserting a mask after each of the plurality of feed-forward neural network layers. For each feed-forward neural network layer, the mask can have non-zero values at positions corresponding to one or more of the plurality of second linear transformation parameters that define the filters in the proper subset, and have zero values at positions corresponding to one or more of the plurality of second linear transformation parameters that define the filters not in the proper subset.

For example, a feed-forward neural network layer FFN^{l}(x) that has N filters can be pruned to have a smaller number n of filters by inserting a mask m ∈R^{N} that has n non-zero values where n<N after the feed-forward neural network layer:

$$( x ) = {\sum }_{i = 1}^{N} ( σ ( {xW}_{ℓ}^{( 1 )} [ : , i ] + {b}_{ℓ}^{( 1 )} ) {W}_{ℓ}^{( 2 )} [ i , : ] ◦ {m}_{i} ) + {b}_{ℓ}^{( 2 )} ,$$

where º is Hadamard product. Thus, in this example, the mask is applied to the layer output of the second linear transformation layer included in the feed-forward neural network layer FFN^{l}(x) by way of determining a Hadamard product between the layer output and the mask.

In some of these implementations, the mask does not scale the filters in the proper subset, and the non-zero values in the mask are the same, e.g., one. In others of these implementations, the mask scales the filters in the proper subset, and the non-zero values in in the mask are generally different from each other. By scaling the filters in the proper subset, the pruning engine 140 mitigates the drop in accuracy due to the reduced number of filters of the neural network that has the pruned architecture 152. For example, the pruning engine 140 can use the scaling transformation techniques described in Kwon, W., et al., A fast post-training pruning framework for transformers. arXiv preprint arXiv:2204.09656, 2022 to determine the non-zero values in the mask for each feed-forward neural network layer by using the unlabeled dataset 104.

By repeatedly generating a pruned feed-forward neural network layer for each of the plurality of feed-forward neural network layers included in the neural network in this manner, the neural network architecture pruning system 100 can generate a pruned architecture 152 for the neural network. In particular, the pruned architecture 152 includes a reduced number of filters in each feed-forward neural network layer compared to the initial architecture 152 (although the pruned architecture 152 will generally include the same number of feed-forward neural network layers as the initial architecture 152).

The neural network architecture pruning system 100 can then output architecture data that specifies the pruned architecture 152 of the neural network, e.g., data specifying the layers that are part of the final architecture, the filters that are included in each of the layers, and the connectivity between the layers. For example, the system can output the architecture data to the user who provided the initial architecture 102, or to another inference system that uses the neural network having the pruned architecture 152 to perform inference.

In some implementations, because the architecture pruning process is gradient-free, i.e., does not involve any updates to the trained values of the parameters 103 of the neural network, the architecture data outputted by the system need not include parameter data that defines the values of the parameters 103 of the neural network. This reduces the bandwidth requirements of the system.

In some implementations, instead of or in addition to outputting the architecture data, the neural network architecture pruning system 100 uses the neural network that has the pruned architecture 152 to process requests received by users, e.g., through the API provided by the system. That is, the neural network architecture pruning system 100 can receive inputs to be processed, use the neural network having the pruned architecture 152 to process the inputs, and provide the outputs generated by the neural network or data derived from the generated outputs in response to the received inputs.

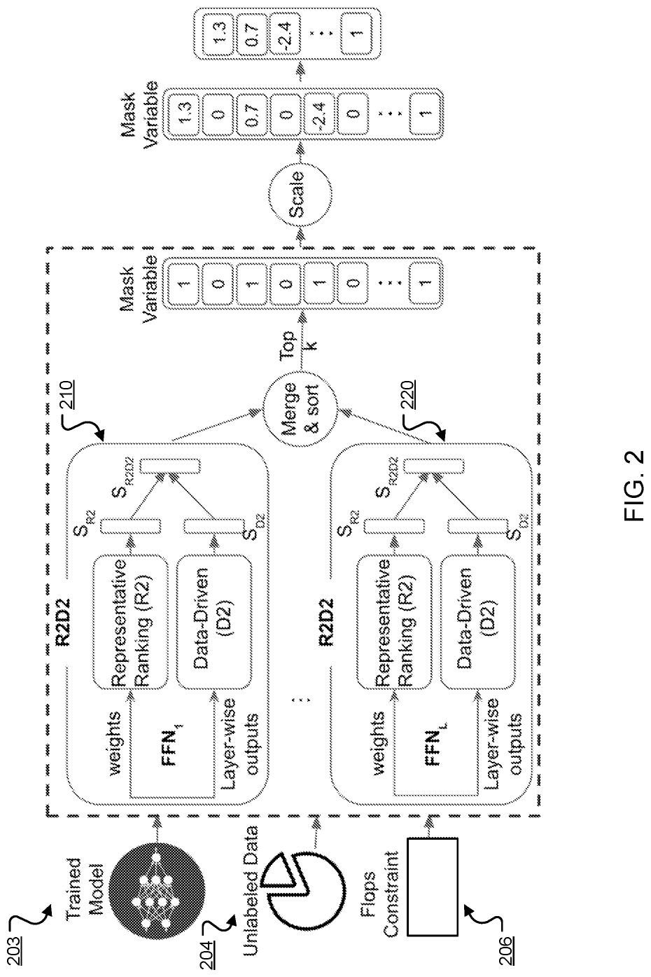

FIG. 2 shows the operations performed by the neural network architecture pruning system 100 of FIG. 1 on a neural network that has an initial architecture to generate a pruned architecture for the neural network.

The neural network architecture pruning system 100 receives an initial architecture 203 of a neural network trained to perform a machine learning task. The system also receives unlabeled dataset 204 that includes a plurality of network inputs, The system further receives input data that specifies a resource constraint 206. In the example of FIG. 2, the resource constraint 206 is defined as the number of floating point operations per second (FLOPS) that are available for use by the neural network.

The operations performed by the neural network architecture pruning system 100 include “R2D2” operations. These “R2D2” operations can be performed independently and e.g., in parallel with each other, for each of a plurality of feed-forward neural network layers, e.g., FFN₁ and FFN_{L}, included in the neural network to select, from a plurality of filters of each of the plurality of feed-forward neural network layers, a proper subset of filters.

The “R2D2” operations include “Representative Ranking (R2)” operations that determine, for each of the plurality of feed-forward neural network layers, a representativeness measure for each of a plurality of filters of the feed-forward neural network layer based on the second linear transformation parameters of the second linear transformation layer included in the feed-forward neural network layer. FIG. 2 thus illustrates that the system determines a representativeness measure S_{R2} for each of the plurality of filters of FFN₁, and a representativeness measure S_{R2} for each of the plurality of filters of FFN_{L}.

The “R2D2” operations also include “data-driven ranking (D2)” operations that determine, for each of the plurality of feed-forward neural network layers, a central tendency measure for each of the plurality of filters of the feed-forward neural network layer based on the layer outputs of the first linear transformation layer included in the feed-forward neural network layer. These layer outputs are generated by the first linear transformation layer while the neural network processes a batch of network inputs sampled from the unlabeled dataset 204. FIG. 2 thus illustrates that the system determines a central tendency measure S_{D2} for each of the plurality of filters of FFN₁, and a central tendency measure S_{D2} for each of the plurality of filters of FFN_{L}.

As a result of performing the “R2D2” operations, the system can determine, for each of the plurality of feed-forward neural network layers, a cumulative importance score for each of the plurality of filters of the feed-forward neural network layer based on the representativeness measures and the central tendency measures. FIG. 2 thus illustrates that the system determines a cumulative importance score S_{R2D2} for each of the plurality of filters of FFN₁, and a cumulative importance score S_{R2D2} for each of the plurality of filters of FFN_{L}.

The neural network architecture pruning system 100 then performs “merge and sort” operations to generate a combined ranking of the plurality of filters included in each of the plurality of feed-forward neural network layers based on their cumulative importance scores. The system then selects filters at the top k positions within the combined ranking. In the example of FIG. 2, k can be the total number of filters that satisfy FLOPS constraint.

A pruned architecture that has k filters across all of the plurality of feed-forward neural network layers, and that omits the remaining filters from the plurality of feed-forward neural network layers, can then be generated.

To generate the pruned architecture, the neural network architecture pruning system 100 inserts a mask after each of the plurality of feed-forward neural network layers. For each feed-forward neural network layer, the mask can have non-zero values at positions corresponding to each of one or more of the plurality of second linear transformation parameters that define the filters that have been selected (as the top k filters), and have zero values at positions corresponding to each of one or more of the plurality of second linear transformation parameters that define the filters that have not been selected. In the example of FIG. 2, the mask scales the filters that have been selected by having non-zero values that are determined using scaling transformation techniques based on the unlabeled dataset 204.

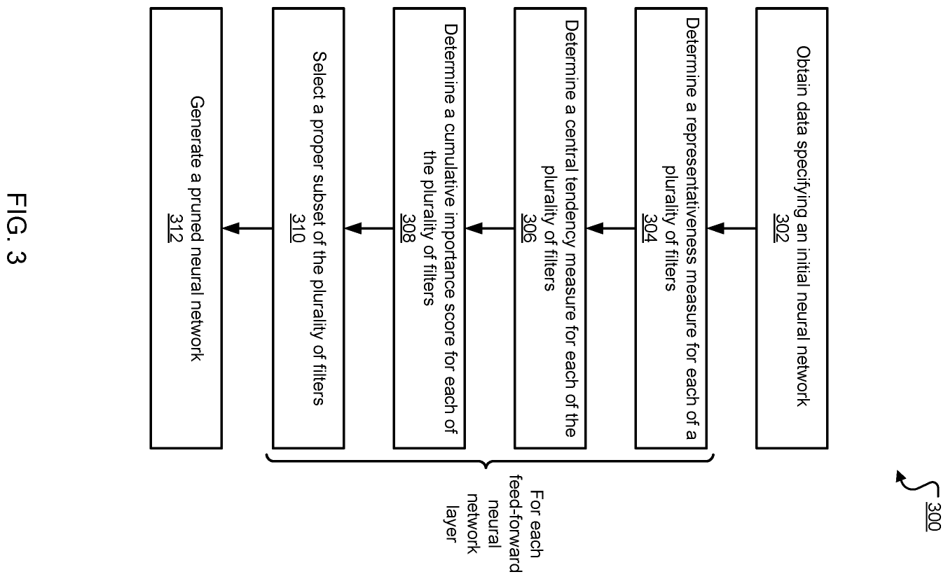

FIG. 3 is a flow diagram of an example process 300 for generating a pruned architecture for a neural network. For convenience, the process 300 will be described as being performed by a system of one or more computers located in one or more locations. For example, a neural architecture search system, e.g., the neural architecture search system 100 of FIG. 1, appropriately programmed, can perform the process 300.

The system obtains (i) data specifying an initial architecture for a neural network that has been configured through training to perform a machine learning task, (ii) data specifying trained values of the parameters of the neural network, (iii) an unlabeled dataset that includes a plurality of network inputs, and, in some implementations, (iv) data specifying one or more resource constraints (step 302). The initial architecture for the neural network includes a plurality of neural network layers. The plurality of neural network layers include a plurality of feed-forward neural network layers. In some implementations, the plurality of neural network layers also include other layers, e.g., multi-head attention layers, embedding layers, output layers, and so on,

Each feed-forward neural network layer includes (i) a first linear transformation layer that has a plurality of first linear transformation parameters followed by (ii) a nonlinear activation layer followed by (iii) a second linear transformation layer that has a plurality of second linear transformation parameters. For each feed-forward neural network layer, the plurality of first linear transformation parameters and the plurality of second linear transformation parameters collectively define the N filters of the feed-forward neural network layer.

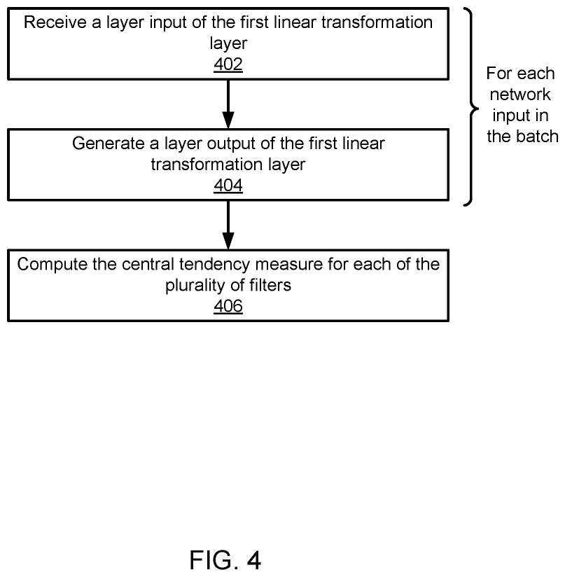

The system can repeatedly perform multiple iterations of steps 304-310 for the plurality of feed-forward neural network layers. For example, the system can begin from the first feed-forward neural network layer, and iterate through all feed-forward neural network layers in the plurality of feed-forward neural network layers. By repeatedly performing iterations of steps 304-310, the system can determine which of the plurality of filters of each feed-forward neural network layer can be included in the pruned architecture, and which of the plurality of filters of each feed-forward neural network layer can be omitted in the pruned architecture. The system determines, for the feed-forward neural network layer, a representativeness measure for each of the plurality of filters of the feed-forward neural network layer (step 304). The representativeness metric indicates how representative each filter is of—or, put another way, how well each filter represents-all of the plurality of filters of the feed-forward neural network layer. The system can determine the representativeness measures from the second linear transformation parameters of the second linear transformation layer included in the feed-forward neural network layer, as will be explained in more detail with reference to FIG. 4, which shows sub-steps 402-406 corresponding to step 304.

The system generates a coefficient matrix C ∈R^{N×N} (step 402). The coefficient matrix C has horizontal and vertical dimensions equal to N, the number of the filters of the feed-forward neural network layer.

The system determines updates to coefficients in the coefficient matrix based on minimizing a difference between (i) the plurality of second linear transformation parameters and (ii) a product of the plurality of second linear transformation parameters and coefficient matrix (step 404). For example, the system minimizes ∥Wₗ⁽²⁾−Wₗ⁽²⁾C∥₂.

Any appropriate update rule can be used to determine such updates. For example, the system can use a non-negative matrix factorization (NMF) update rule, a semi-NMF update rule, or a nonnegative least square update rule. As a particular example, the system can use a semi-NMF update rule to update the coefficients in the coefficient matrix over a plurality of update iterations. At each update iteration, the coefficient matrix C is computed as:

$${C}^{i + 1} = {C}^{i} ◦ \sqrt{\frac{K ( {W}_{ℓ}^{( 2 )} , {W}_{ℓ}^{( 2 )} )}{K ( {W}_{ℓ}^{( 2 )} , {W}_{ℓ}^{( 2 )} ) {C}^{i}}} ,$$

where K is a Gaussian kernel. Semi-NMF update rule is described in more detail in Huang, C., at al. Kernelized convex hull approximation and its applications in data description tasks. In 2018 International Joint Conference on Neural Networks (IJCNN), pp. 1-8. IEEE, 2018.

The system uses the updated coefficients along a diagonal of the coefficient matrix as the representativeness measures for the plurality of filters (step 406). For example, when the semi-NMF update rule is used, the system can use the coefficients along the diagonal of a coefficient matrix that is computed in the last update iteration as the representativeness measures for the plurality of filters.

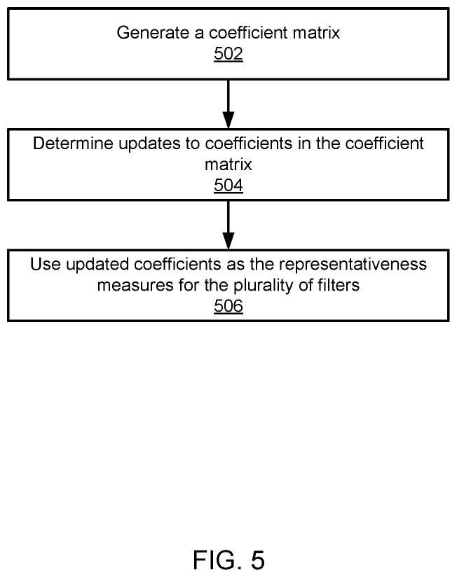

The system determines a central tendency measure for each of the plurality of filters of the feed-forward neural network layer (step 306). Determining the central tendency measures can involve sampling a batch of network inputs from the unlabeled dataset and processing the network inputs in the batch using the initial neural network, as will be explained in more detail with reference to FIG. 5, which shows sub-steps 502-506 corresponding to step 304.

For each network input in the batch, the system receives a layer input of the first linear transformation layer included in the feed-forward neural network layer, and processes the layer input in accordance with the plurality of first linear transformation parameters to generate a layer output of the first linear transformation layer (step 502). The layer input of the first linear transformation layer can generally be any intermediate data derived from the network input. For example, the layer input can be the layer output of a preceding layer, e.g., a multi-head attention layer, an embedding layer, or another feed-forward neural network layer, within the neural network.

For example, the system can generate the layer output of the first linear transformation layer by computing:

$${H}_{ℓ}^{( 1 )} = σ ( {xW}_{ℓ}^{( 1 )} + {b}_{ℓ}^{( 1 )} ) .$$

The system computes the central tendency measure for each of the plurality of filters based on output values included in the layer outputs of the first linear transformation layer for the network inputs in the batch (step 504). For each of the plurality of filters of the feed-forward neural network layer, the central tendency measure can, for example, be the mean, normalized mean, or median of the output values generated by the filter for the network inputs in the batch. A normalized mean is a mean of the output values that has been normalized to a predetermined range (e.g., a range that corresponds to possible values for the representativeness measures).

The system determines, based on the representativeness measure and the central tendency measure, a cumulative importance score for each of the plurality of filters of the feed-forward neural network layer (step 308). For example, for each filter, the cumulative importance score can be a combination, e.g., a sum or product, of its representativeness measure and central tendency measure.

The system selects, based on the cumulative importance scores, a proper subset of the plurality of filters (step 310). In some implementations, the system can select a fixed number of filters from each feed-forward neural network layer included in the initial architecture of the neural network. For example, the system can rank the plurality of filters of the given feed-forward neural network layer based on their cumulative importance scores to generate a ranking, and then select the filters at the top k positions within the ranking for each feed-forward neural network layer.

In other implementations, the system can select a varying number of filters from each feed-forward neural network layers included in the initial architecture of the neural network. For example, the system can generate a combined ranking for all of the plurality of feed-forward neural network layers included in the initial architecture of the neural network based on their cumulative importance scores, and select filters at the top k positions within the combined ranking.

In either implementations, the value of k can be a tunable parameter of the system. For example, the value of k can be a predetermined value, e.g., that is received from a user of the system. As another example, the system can dynamically adjust the value of k based on the resource constraints received by the system. For example, the system can determine the maximum number of filters across the plurality of feed-forward neural network layers included in the initial architecture of the neural network that are allowed in the pruned architecture in order to satisfy the resource constraints, and set k to a value that is no greater than the maximum allowed number.

The system generates the pruned architecture for the neural network configured to perform the machine learning task (step 312). The pruned neural network includes a plurality of pruned feed-forward neural network layers that correspond respectively to the plurality of feed-forward neural network layers included in the initial architecture. Each pruned feed-forward neural network layer has the filters in the proper subset of filters that have been selected from the corresponding feed-forward neural network layer, and omits the remaining filters that are not in the proper subset of filters. That is, to generate the pruned architecture, the system prunes the filters that have not been selected from the feed-forward neural network layers included in the initial architecture.

In some implementations, filters that are not in the proper subsets of filters are pruned from the initial architecture by inserting a mask after each of the plurality of feed-forward neural network layers. For each feed-forward neural network layer, the mask can have non-zero values at positions corresponding to one or more of the plurality of second linear transformation parameters that define the filters in the proper subset, and have zero values at positions corresponding to one or more of the plurality of second linear transformation parameters that define the filters not in the proper subset.

The example algorithms for generating a pruned architecture for a neural network are shown below.

Algorithm 1 Kernelized Convex Masking (KCM)

| | |
|---|---|
| 1: | Input: Trained model: Model, FLOPs constraint [symbol] , Gaussian |
| | Kernel K, convergence rate α |
| 2: | Output: Mask [symbol] |
| 3: | Initialize mask [symbol] as 0 |
| | //Call Representative Ranking (R2) Algorithm 2 |
| 4: | S_{R2} = R2(Model, K, α) |
| | // Data-Driven (D2) Ranking |
| 5: | for batch in sample-data do |
| 6: | for each layer [symbol] in Model collect [symbol] |
| 7: | S_{D2}[ [symbol] ] = average over [symbol] for each filter |
| 8: | end for |
| 9: | S_{R2D2}[ [symbol] ] = S_{R2}[ [symbol] ] * normalized(S_{D2}[ [symbol] ]) |
| 10: | k = Number of neurons to satisfy FLOPs constraint [symbol] |
| 11: | Candidates = top-k filters of the sorted S_{R2D2} |
| 12: | [symbol] [Candidates] = 1.0 |
| 13: | return [symbol] |

Algorithm 2 Representative Ranking (R2)

```
  1: Input: Trained model: Model, Gaussian Kernel K with width σ,
    convergence rate α
  2: Output: S_{R2} that represents importance of Filters in all layers.
  3: for layer [symbol]  in layers of the Model do
  4: [symbol]   ∈ [symbol] ^{N×d} of FF [symbol]
  $5 : Initialize coefficient matrix : {C}_{0} ∈ {ℝ}^{N \times N} = \frac{1}{N}$
  6:  repeat
  $7 : {C}_{i + 1} = {C}_{i} ◦ \sqrt{\frac{K ( {W}_{ℓ}^{( 2 )} , {W}_{ℓ}^{( 2 )} )}{K ( {W}_{ℓ}^{( 2 )} , {W}_{ℓ}^{( 2 )} ) {C}_{i}}}$
  $8 : δ = \frac{( {C}_{i + 1} - {C}_{i} ) \cdot sum ( )}{{C}_{i} \cdot sum}$
  9:  Cᵢ = Cᵢ₊₁
10:  until convergence i.e. δ ≤ α
11:  S_{R2}[ [symbol] ] = diagonal(Cᵢ)
12: end for
13: return S_{R2}
```

In the example algorithms shown above, a semi-NMF update rule is used to determine the representativeness measures for the plurality of filters (lines 3-11 in Algorithm 2). The central tendency measure is computed as the normalized mean of the plurality of filters of a given feed-forward neural network layer (line 9 in Algorithm 1). The non-zero values in the mask are set to one (line 12 in Algorithm 1).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
obtaining data specifying an initial neural network configured to perform a machine learning task, wherein the initial neural network comprises a plurality of neural network layers, wherein the plurality of neural network layers comprise a feed-forward neural network layer that comprises (i) a first linear transformation layer that has a plurality of first linear transformation parameters followed by (ii) a nonlinear activation layer followed by (iii) a second linear transformation layer that has a plurality of second linear transformation parameters, the plurality of first linear transformation parameters and the plurality of second linear transformation parameters defining a plurality of filters of the feed-forward neural network layer;
determining, from the second linear transformation parameters, a representativeness measure for each of the plurality of filters, wherein the representativeness measure indicates how representative each filter is of all of the plurality of filters;
determining a central tendency measure for each of the plurality of filters based on processing a batch of network inputs using the initial neural network, wherein determining the central tendency measure comprises,
for each network input in the batch of network inputs:
receiving a layer input of the first linear transformation layer; and
processing the layer input in accordance with the plurality of first linear transformation parameters to generate a layer output of the first linear transformation layer; and
computing the central tendency measure for each of the plurality of filters based on output values included in the layer outputs of the first linear transformation layer for the network inputs in the batch;
determining, based on the representativeness measures and the central tendency measures, a cumulative importance score for each of the plurality of filters;
selecting, based on the cumulative importance scores, a proper subset of the plurality of filters; and
generating a pruned neural network configured to perform the machine learning task, wherein the pruned neural network comprises a pruned feed-forward neural network layer having the proper subset of the plurality of filters.

2. The method of claim 1, wherein generating the pruned neural network comprises:
generating a mask that assigns a non-zero value to each of one or more of the plurality of second linear transformation parameters that define the proper subset of the plurality of filters; and
applying the mask to a layer output of the second linear transformation layer.

3. The method of claim 2, wherein applying the mask comprises determining a Hadamard product between the layer output and the mask.

4. The method of claim 2, wherein the non-zero values in the mask are one.

5. The method of claim 2, wherein the non-zero values in the mask are different from each other.

6. The method of claim 1, wherein determining the representativeness measure for each of the plurality of filters comprises:
generating a coefficient matrix having horizontal and vertical dimensions equal to a number of the plurality of filters of the feed-forward neural network layer;
determining updates to coefficients in the coefficient matrix based on minimizing a difference between (i) the plurality of second linear transformation parameters and (ii) a product of the plurality of second linear transformation parameters and coefficient matrix; and
using updated coefficients along a diagonal of the coefficient matrix as the representativeness measures for the plurality of filters.

7. The method of claim 6, wherein determining updates to coefficients in the coefficient matrix comprises:
applying a non-negative matrix factorization (NMF) update rule, a semi-NMF update rule, or nonnegative least square update rule.

8. The method of claim 1, wherein processing the batch of network inputs using the initial neural network comprises:
obtaining the batch of network inputs from an unlabeled dataset.

9. The method of claim 1, wherein selecting the proper subset of the plurality of filters comprises:
receiving data defining a resource constraint that specify how many computational resources can be consumed by the pruned neural network when performing the machine learning task;
generating a ranking of the plurality of filters based on the cumulative importance score for each of the plurality of filters; and
selecting, in accordance with the ranking and the resource constraint, the proper subset of the plurality of filters.

10. The method of claim 1, wherein the nonlinear activation layer comprises a Gaussian error linear unit (GELU) activation layer or a rectified linear unit (RELU) activation layer.

11. A system comprising one or more computers and one or more storage devices storing instructions that are operable, when executed by the one or more computers, to cause the one or more computers to perform operations comprising:
obtaining data specifying an initial neural network configured to perform a machine learning task, wherein the initial neural network comprises a plurality of neural network layers, wherein the plurality of neural network layers comprise a feed-forward neural network layer that comprises (i) a first linear transformation layer that has a plurality of first linear transformation parameters followed by (ii) a nonlinear activation layer followed by (iii) a second linear transformation layer that has a plurality of second linear transformation parameters, the plurality of first linear transformation parameters and the plurality of second linear transformation parameters defining a plurality of filters of the feed-forward neural network layer;
determining, from the second linear transformation parameters, a representativeness measure for each of the plurality of filters, wherein the representativeness measure indicates how representative each filter is of all of the plurality of filters;
determining a central tendency measure for each of the plurality of filters based on processing a batch of network inputs using the initial neural network, wherein determining the central tendency measure comprises,
for each network input in the batch of network inputs:
receiving a layer input of the first linear transformation layer; and
processing the layer input in accordance with the plurality of first linear transformation parameters to generate a layer output of the first linear transformation layer; and
computing the central tendency measure for each of the plurality of filters based on output values included in the layer outputs of the first linear transformation layer for the network inputs in the batch;
determining, based on the representativeness measures and the central tendency measures, a cumulative importance score for each of the plurality of filters;
selecting, based on the cumulative importance scores, a proper subset of the plurality of filters; and
generating a pruned neural network configured to perform the machine learning task, wherein the pruned neural network comprises a pruned feed-forward neural network layer having the proper subset of the plurality of filters.

12. The system of claim 11, wherein generating the pruned neural network comprises:
generating a mask that assigns a non-zero value to each of one or more of the plurality of second linear transformation parameters that define the proper subset of the plurality of filters; and
applying the mask to a layer output of the second linear transformation layer.

13. The system of claim 12, wherein applying the mask comprises determining a Hadamard product between the layer output and the mask.

14. The system of claim 12, wherein the non-zero values in the mask are one.

15. The system of claim 12, wherein the non-zero values in the mask are different from each other.

16. The system of claim 11, wherein determining the representativeness measure for each of the plurality of filters comprises:
generating a coefficient matrix having horizontal and vertical dimensions equal to a number of the plurality of filters of the feed-forward neural network layer;
determining updates to coefficients in the coefficient matrix based on minimizing a difference between (i) the plurality of second linear transformation parameters and (ii) a product of the plurality of second linear transformation parameters and coefficient matrix; and
using updated coefficients along a diagonal of the coefficient matrix as the representativeness measures for the plurality of filters.

17. The system of claim 16, wherein determining updates to coefficients in the coefficient matrix comprises:
applying a non-negative matrix factorization (NMF) update rule, a semi-NMF update rule, or nonnegative least square update rule.

18. The system of claim 11, wherein processing the batch of network inputs using the initial neural network comprises:
obtaining the batch of network inputs from an unlabeled dataset.

19. The system of claim 11, wherein selecting the proper subset of the plurality of filters comprises:
receiving data defining a resource constraint that specify how many computational resources can be consumed by the pruned neural network when performing the machine learning task;
generating a ranking of the plurality of filters based on the cumulative importance score for each of the plurality of filters; and
selecting, in accordance with the ranking and the resource constraint, the proper subset of the plurality of filters.

20. A computer storage medium encoded with instructions that, when executed by one or more computers, cause the one or more computers to perform operations comprising:
obtaining data specifying an initial neural network configured to perform a machine learning task, wherein the initial neural network comprises a plurality of neural network layers, wherein the plurality of neural network layers comprise a feed-forward neural network layer that comprises (i) a first linear transformation layer that has a plurality of first linear transformation parameters followed by (ii) a nonlinear activation layer followed by (iii) a second linear transformation layer that has a plurality of second linear transformation parameters, the plurality of first linear transformation parameters and the plurality of second linear transformation parameters defining a plurality of filters of the feed-forward neural network layer;
determining, from the second linear transformation parameters, a representativeness measure for each of the plurality of filters, wherein the representativeness measure indicates how representative each filter is of all of the plurality of filters;
determining a central tendency measure for each of the plurality of filters based on processing a batch of network inputs using the initial neural network, wherein determining the central tendency measure comprises,
for each network input in the batch of network inputs:
receiving a layer input of the first linear transformation layer; and
processing the layer input in accordance with the plurality of first linear transformation parameters to generate a layer output of the first linear transformation layer; and
computing the central tendency measure for each of the plurality of filters based on output values included in the layer outputs of the first linear transformation layer for the network inputs in the batch;
determining, based on the representativeness measures and the central tendency measures, a cumulative importance score for each of the plurality of filters;
selecting, based on the cumulative importance scores, a proper subset of the plurality of filters; and
generating a pruned neural network configured to perform the machine learning task, wherein the pruned neural network comprises a pruned feed-forward neural network layer having the proper subset of the plurality of filters.
